(19) United States
(12) Patent Application Publication
(10) Pub. No.: US 2009/0301384 A1
(43) Pub. Date: Dec. 10, 2009

(54) Flexible Electronic Bookmark

(76) Inventor: Claude Maurice Beauregard, JR., Canton, MI (US)

Correspondence Address: Claude Maurice Beauregard Jr., 43505 Gatehouse Ct, Canton, MI, 48187, US

(21) Appl. No.: 12/157,147

(22) Filed: Jun. 9, 2008

(51) Int. Cl. B42D 9/00

(52) U.S. Cl. 116/234

(57) ABSTRACT

The present invention relates to a flexible bookmark and more particularly a bookmark capable of displaying active text and images on its surface.

### REFERENCES SITED:

U.S. Patent Documents

U.S. Pat. No. 2,630,777 Johnson

U.S. Pat. No. 2,964,010 Harrison

U.S. Pat. No. 5,311,835 Knowles

U.S. Pat. No. 5,462,006 Thiruppathi

U.S. Pat. No. 5,515,809 Weinberg

U.S. Pat. No. 5,819,451 Khon

U.S. Pat. No. 7,260,025 Farinella et al

USD560720 Madden et al

USD313627 Diaz

USD534584 Goldberg et al

US20050242567 Palamidessi

### FIELD OF INVENTION

Convention bookmarks are used to mark or identify two pages of text. They can also be used to identify the location of a particular section of text on a page. And while the bookmark themselves can have different graphic images and text printed on their surface. Those images like the text are stagnant and non-moving.

### BRIEF SUMMARY OF THE INVENTION

It is an object of the present invention to provide a flexible electronic bookmark which will allow for the display of moving text and images on its surface. This is achieved by the flexible electronic bookmark provided by the present invention, in which a substrate of a thickness suitable for use between pages. The substrate will be composed of a thin electronic display or some other media suitable for the display of moving text and images on its surface, and appropriate circuitry. The thin electronic display or media should be flexible in nature so that it will not be damaged as the flexible electronic bookmark bends. A flexible material completes the backing of the flexible electronic bookmark and protects the control circuitry. At one end of the bookmark is a male plug.

### BRIEF DESCRIPTION OF DRAWINGS

In this preferred embodiment:

FIG. 1 is a perspective view of the flexible electronic bookmark

FIG. 1a is a perspective view of the flexible substrate backing

FIG. 1b is a perspective view of the flexible electronic circuit board

FIG. 1c is a perspective view of the flexible electronic display unit

FIG. 2 is a frontal view of the flexible electronic bookmark

FIG. 3 is a rear view of the flexible electronic bookmark.

FIG. 4 is a top view of the flexible electronic bookmark

FIG. 5 is a bottom view of the flexible electronic bookmark

FIG. 6 is a right side view of the flexible electronic bookmark; the left side view of the flexible electronic bookmark is a mirror image of the right side.

FIG. 7 is a rear view of the flexible electronic bookmark with break away cover section

### DETAILED DESCRIPTION OF INVENTION

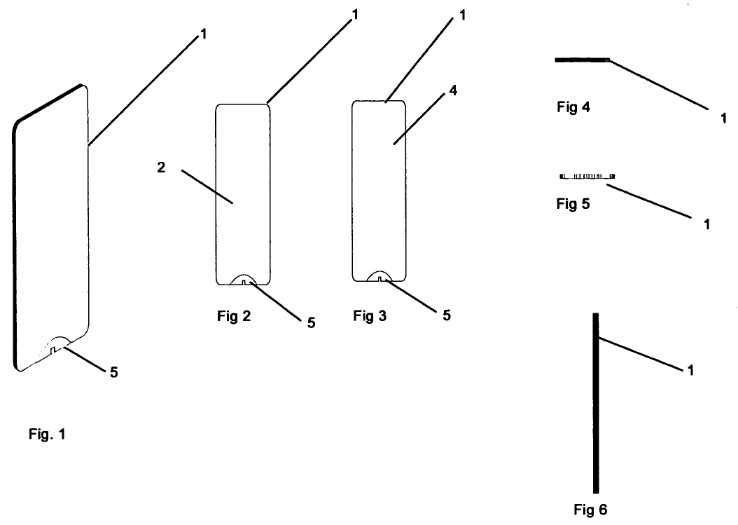

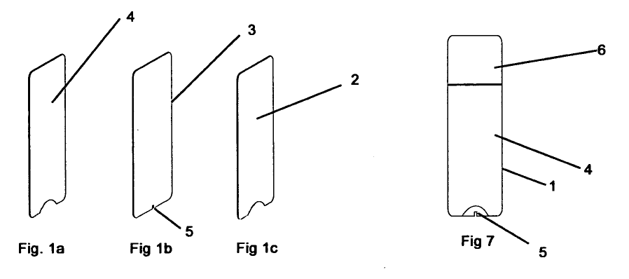

In the preferred embodiment as described in FIG. 1 the flexible electronic bookmark (1) is comprised of a thin flexible electronic display unit (2) with appropriate flexible electronic circuit board (3) used for controlling the display of text and images and regulating voltage and a substrate backing (4). These components are combined using an appropriate method to form one single flexible electronic bookmark (1) as pictured in FIGS. 1 through 6 As demonstrated in FIG. 1b, the flexible electronic circuit board (3) is thin enough to remain flexible yet house the necessary circuitry to control the display of images and text on the flexible electronic display unit (2) of FIG. 1c. In the preferred embodiment the flexible electronic display unit (2) is comprised of a thin-film polymer or other flexible substrate capable of displaying moving text and images. This flexible substrate or polymer is attached to the flexible electronic circuit board (3) which is comprised of printed electronics or some other means of electronic fabrication, which then controls the display of text and images on the flexible electronic display unit (2). The flexible electronic display unit (2) is attached to the flexible electronic circuit board (3) by some appropriate means. The flexible electronic bookmark (1) also has at one end a notched male plug (5) which is used to plug the bookmark into an appropriate device for programming text or images into the bookmark's memory unit housed on the flexible electronic circuit board (3).

As demonstrated in FIG. 3 and 1a, the flexible substrate backing (4) is used to provide additional stability and protection to the flexible electronic bookmark (1).

This represents the preferred embodiment however those skilled in the art will appreciate that various adaptations and modifications of the just-described preferred embodiment can be configured without departing from the scope and spirit of the invention. Therefore, it is to be understood that within the scope of the appended claims the invention may be practiced other than as specifically described herein.

Another modification of the flexible electronic bookmark (1) as pictured in FIG. 7 the flexible substrate backing (4) has a break away cover (6) that can house a battery power unit connected to the flexible electronic circuit board (3) by some means. Said battery power unit being thin enough to properly fit into a cavity provided by the removal of break away cover (6).

In another modification is to include a RFID device capable of receiving information for display on the flexible electronic bookmark (1) from another source such a wireless router or some other device capable of streaming information wirelessly to a receiving device.

In another modification of the device the flexible substrate backing (4) can be composed of a flexible solar cell material capable of recharging the battery for the flexible electronic bookmark (1)

1. A flexible electronic bookmark with a flexible electronic display capable of displaying text, moving text and images on its surface.

2. A flexible electronic bookmark with a compartment for housing a power supply.

3. A flexible electronic bookmark capable of receiving images and text via wireless communications
